(19) United States
(12) Patent Application Publication
(10) Pub. No.: US 2025/0121526 A1
(43) Pub. Date: Apr. 17, 2025

(54) METHODS AND SYSTEMS FOR CONVEYING ABRASIVES TO UNDERWATER OBJECTS FOR CUTTING

(71) Applicant: GRADIENT TECHNOLOGY, Elk River, MN (US)

(72) Inventors: Nathan F. NODLAND, Maple Grove, MN (US); Jacqueline R. HITCHINGHAM, Andover, MN (US); Drew A. STROMBECK, Plymouth, MN (US); Ryan M. SMITH, Minnetonka, MN (US); Steve J. SCHMIT, Orono, MN (US)

(21) Appl. No.: 18/380,639

(22) Filed: Oct. 16, 2023

(51) Int. Cl. B26F 3/00; B24C 1/04; B24C 7/00; B24C 11/00

(52) U.S. Cl. CPC B26F 3/004; B24C 1/045; B24C 7/0084; B24C 11/00

(57) ABSTRACT

The invention provides a system for conveying an abrasive to cut an underwater object (e.g., unexploded ordnance), comprising: a cutting head comprising a high-pressure-water inlet, an abrasive inlet, a mixing chamber, and a focusing tube; a high-pressure water line configured to flow high-pressure water into the mixing chamber; an abrasive line configured to flow an abrasive into the mixing chamber; and a pressurized gas vessel connected to a sealed gas-valve chamber configured to reduce gas pressure to a conveyance pressure greater than atmospheric pressure. When the abrasive valve is open, the abrasive is conveyed from the abrasive feeder vessel into the mixing chamber, and the gas pneumatically conveys the abrasive from the abrasive feeder vessel to the mixing chamber. The focusing tube directs the high-velocity waterjet and the abrasive onto the underwater object for cutting. Methods are also described for using the disclosed system to cut an underwater object.

### FIELD OF THE INVENTION

The present invention generally relates to the use of abrasive waterjet technology to cut objects located at the bottom of a body of water.

### BACKGROUND OF THE INVENTION

Munitions are encountered in a variety of underwater environments as unexploded ordnance or discarded military munitions. These underwater objects can cause unacceptable explosive risk to critical infrastructure, recreational divers, and fishermen. The objects can also wash up on-shore and place people at serious risk of death or injury from an explosion.

The problem is widespread. Discarded military munitions and unexploded ordnance are found in the waters surrounding nearly every active, or formerly active, coastal military target range or military ammunition port in the United States. The U.S. Department of Defense seeks to remove or deactivate these underwater objects in sensitive marine environments and those with significant public access, such as Culebra and Vieques, Puerto Rico, as well as Ordnance Reef in Hawaii.

The problem is certainly not limited to the United States. Internationally, in view of the increasing utilization of the seafloor for economic purposes (e.g. offshore wind farms, sea cables, and pipelines), the risk of encountering sea-dumped munitions is increasing. For example, many undersea munitions historically dumped in the Baltic Sea are now causing problems for developing wind farms on the sea. The European Parliament adopted a resolution in 2021 calling on European Union member states to jointly solve the problem of chemical weapons dumped in the framework of NATO-led operations (source: https://balticwind.eu, “Do WWII weapons dumped in the Baltic Sea pose a threat to wind energy?” retrieved Sep. 14, 2023).

Remediation of discarded munitions located underwater has historically required placement of detonation charges by explosive ordnance disposal divers or recovery of the hazardous and potentially unstable ordnance for demilitarization of the munition on the surface (above water). In the case of explosive detonation, there is danger even to highly skilled divers when placing the explosive charges. Also, fish and marine mammals such as whales and dolphins can be killed or seriously injured up to several kilometers from an underwater detonation due to the explosive shock.

There is a desire to perform in situ demilitarization of munitions underwater, by providing a tool package that can be deployed and operated from the surface. Such a system would avoid the need for divers to interact with underwater ordnance during remediation, avoiding potentially significant human impacts.

It is well-known that waterjets may be used to cut objects. Waterjets are fast, flexible, reasonably precise, and relatively easy to use. Waterjets utilize high-pressure water being forced through a small orifice to concentrate an extreme amount of energy in a small area. The restriction of the tiny orifice creates a high-pressure and high-velocity thin jet of water. When an abrasive material is added to the waterjet, the resulting mixture of water and abrasive is usually more effective for cutting an object.

Entrainment-style abrasive waterjets are known. An entrainment-style abrasive waterjet uses a high-velocity fluid jet, formed by pressurized water passing through an orifice of a cutting head, resulting in a partial vacuum that aspirates and entrains abrasive particles to pre-mix the abrasive with the fluid jet. Entrainment-style abrasive waterjets have some advantages over abrasive-slurry waterjets. For example, entrainment-style abrasive waterjets require less maintenance, can operate at internal system pressures up to 10,000 atm or more, can operate continuously, do not require costly chemical additives, and use less abrasive, compared to abrasive-slurry waterjets.

While the art suggests the possibility of using waterjet technology for underwater cutting, serious problems still exist and must be overcome before such technology can be used commercially, especially in deep water. Obstacles include being able to feed a steady flow of abrasive to the cutting head underwater.

### SUMMARY OF THE INVENTION

Some variations of the invention provide a method of conveying an abrasive to cut an underwater object, the method comprising:
(a) providing a cutting head comprising a high-pressure-water inlet, an abrasive inlet, a mixing chamber, and a focusing tube that forms an outlet from the mixing chamber;
(b) providing a high-pressure water line that is configured to flow high-pressure water into the mixing chamber via the high-pressure-water inlet;
(c) providing an abrasive line that is configured to flow an abrasive, from an abrasive feeder vessel and through an abrasive valve, into the mixing chamber via the abrasive inlet;
(d) providing a pressurized gas vessel containing a gas at a source pressure, wherein the pressurized gas vessel is connected to a sealed gas-valve chamber that is configured to reduce gas pressure from the source pressure to a conveyance pressure greater than atmospheric pressure, and wherein the sealed gas-valve chamber is directly or indirectly connected to the abrasive feeder vessel;
(e) opening a valve upstream of the cutting head to form a high-velocity waterjet through the focusing tube that receives the high-pressure water from the mixing chamber;
(f) evacuating the abrasive line of residual water;
(g) after step (f), opening the abrasive valve to receive the abrasive from the abrasive feeder vessel into the mixing chamber, and to receive the gas from the abrasive feeder vessel into the mixing chamber, wherein the gas at the conveyance pressure pneumatically conveys the abrasive from the abrasive feeder vessel to the mixing chamber; and
(h) cutting the underwater object using the high-velocity waterjet and the abrasive.

In preferred embodiments, the cutting head is an entrainment-style waterjet cutting head.

The high-pressure water may be at a pressure selected from about 1000 atm to about 10000 atm.

The abrasive may be selected from the group consisting of garnet, diamond, silicon carbide, silica, alumina, titanium dioxide, and combinations thereof.

In some embodiments, the abrasive feeder vessel is connected at an abrasive-feeder inlet to an abrasive hopper that stores the abrasive.

In some embodiments, the abrasive feeder vessel is internally configured with an abrasive feeder. A funnel may be disposed at an outlet of the abrasive feeder, at a distal end relative to the abrasive-feeder inlet.

In some embodiments, the gas-valve chamber is directly connected to the abrasive feeder vessel. In some embodiments, the gas-valve chamber is connected to an abrasive hopper. In certain embodiments, the gas-valve chamber is connected to both the abrasive feeder vessel and the abrasive hopper.

The gas may be selected from the group consisting of air, nitrogen, argon, carbon dioxide, and combinations thereof. In typical embodiments, the gas is dry air.

In step (d), there is at least one pressurized gas vessel. Multiple pressurized gas vessels may be utilized, potentially with different volumes or pressures. In certain embodiments, standard scuba air jugs are utilized.

The source pressure for the gas may be selected from about 10 atm to about 250 atm.

The conveyance pressure for the gas may be selected from about 1.1 atm to about 2 atm, for example. Higher conveyance pressures may be used, such as 5 atm.

The sealed gas-valve chamber is at a reference pressure, which is typically 1 atm. The reference pressure is less than the source pressure. In preferred embodiments, the reference pressure is less than the conveyance pressure. In some embodiments, the sealed gas-valve chamber contains a blanketing regulator valve that maintains the conveyance pressure of the gas feeding into the abrasive feeder vessel.

In some embodiments, step (f) evacuates the abrasive line of residual water using the Venturi effect by flowing high-pressure water past the abrasive inlet for at least 10 seconds. In some embodiments, step (f) evacuates the abrasive line of residual water using flow of gas through the abrasive line. In certain embodiments, step (f) evacuates the abrasive line of residual water using both (i) the Venturi effect by flowing high-pressure water past the abrasive inlet for at least 10 seconds and (ii) flow of gas through the abrasive line, either simultaneously or at different times.

Step (f) may employ an abrasive flow rate from about 0.1 pounds per minute to about 2 pounds per minute, for example.

Step (g) may employ a gas flow rate from about 1 standard cubic feet per minute to about 5 standard cubic feet per minute, for example.

In step (h), the underwater object being cut may be a discarded military munition or an unexploded ordnance, for example. The underwater object may be an object other than a munition.

Some variations of the invention provide a system for conveying an abrasive intended to cut an underwater object, the system comprising:
(a) a cutting head comprising a high-pressure-water inlet, an abrasive inlet, a mixing chamber, and a focusing tube that forms an outlet from the mixing chamber;
(b) a high-pressure water line that is configured to flow high-pressure water into the mixing chamber via the high-pressure-water inlet, wherein the focusing tube is configured to receive the high-pressure water from the mixing chamber;
(c) an abrasive line that is configured to flow an abrasive, from an abrasive feeder vessel and through an abrasive valve, into the mixing chamber via the abrasive inlet; and
(d) a pressurized gas vessel containing a gas at a source pressure, wherein the pressurized gas vessel is connected to a sealed gas-valve chamber that is directly or indirectly connected to the abrasive feeder vessel, wherein the sealed gas-valve chamber is configured to reduce gas pressure from the source pressure to a conveyance pressure greater than atmospheric pressure,
wherein, when the abrasive valve is open, (i) the abrasive is conveyed from the abrasive feeder vessel into the mixing chamber and (ii) the gas at the conveyance pressure pneumatically conveys the abrasive from the abrasive feeder vessel to the mixing chamber, and wherein the focusing tube is configured to direct the high-velocity waterjet and the abrasive onto the underwater object.

In preferred systems, the cutting head is an entrainment-style waterjet cutting head.

In some systems, the abrasive feeder vessel is connected at an abrasive-feeder inlet to an abrasive hopper that stores the abrasive. The abrasive feeder vessel may be internally configured with an abrasive feeder, and a funnel may be disposed at an outlet of the abrasive feeder, at a distal end relative to the abrasive-feeder inlet.

In some systems, the gas-valve chamber is directly connected to the abrasive feeder vessel. In some systems, the gas-valve chamber is connected to the abrasive hopper. In certain systems, the gas-valve chamber is connected to both the abrasive feeder vessel and the abrasive hopper.

In some systems, the sealed gas-valve chamber contains a blanketing regulator valve that is configured to maintain the conveyance pressure of the gas feeding into the abrasive feeder vessel.

The underwater object to be cut may be a discarded military munition or an unexploded ordnance, for example.

Other variations of the invention provide a method of conveying an abrasive to cut an object submerged in shallow water, the method comprising:
(a) providing a cutting head comprising a high-pressure-water inlet, an abrasive inlet, a mixing chamber, and a focusing tube that forms an outlet from the mixing chamber;
(b) providing a high-pressure water line that is configured to flow high-pressure water into the mixing chamber via the high-pressure-water inlet;
(c) providing an abrasive line that is configured to flow an abrasive, from an abrasive feeder vessel and through an abrasive valve, into the mixing chamber via the abrasive inlet;
(d) providing an air conduit configured to supply ambient air directly or indirectly to the abrasive feeder vessel;
(e) opening a valve upstream of the cutting head to form a high-velocity waterjet through the focusing tube that is configured to receive the high-pressure water from the mixing chamber;
(f) evacuating the abrasive line of residual water;
(g) after step (f), opening the abrasive valve to receive the abrasive from the abrasive feeder vessel into the mixing chamber, and to receive the ambient air from the abrasive feeder vessel into the mixing chamber, wherein the ambient air pneumatically conveys the abrasive from the abrasive feeder vessel to the mixing chamber; and
(h) cutting the underwater object using the high-velocity waterjet and the abrasive.

Other variations of the invention provide a system for conveying an abrasive intended to cut an underwater object, the system comprising:
a cutting head comprising a high-pressure-water inlet, an abrasive inlet, a mixing chamber, and a focusing tube that forms an outlet from the mixing chamber;
a high-pressure water line that is configured to flow high-pressure water into the mixing chamber via the high-pressure-water inlet, wherein the focusing tube is configured to receive the high-pressure water from the mixing chamber;
an abrasive line that is configured to flow an abrasive, from an abrasive feeder vessel and through an abrasive valve, into the mixing chamber via the abrasive inlet; and
an air conduit configured to supply ambient air directly or indirectly to the abrasive feeder vessel,
wherein, when the abrasive valve is open, (i) the abrasive is conveyed from the abrasive feeder vessel into the mixing chamber and (ii) the gas pneumatically conveys the abrasive from the abrasive feeder vessel to the mixing chamber, and wherein the focusing tube is configured to direct the high-velocity waterjet and the abrasive onto the underwater object.

### BRIEF DESCRIPTION OF THE DRAWINGS

FIG. 1 is an exemplary system for conveying an abrasive intended to cut an underwater object, including gas storage 1, forward pressure regulator 2, blanketing regulator valve chamber 3, blanketing regulator valve 4, chamber reference pressure valve 5, abrasive hopper 6, abrasive feeder vessel 7, pressure equilibration conduit 8, abrasive feeder 9, abrasive funnel 10, abrasive actuated valve 11, abrasive conduit 12, high-pressure-water actuated valve 13, entrainment-style abrasive cutting head 14, and focusing tube 15.

FIG. 2 is an exemplary system for conveying an abrasive intended to cut an underwater object submerged in shallow water, including vent line 1 (to surface above water), abrasive hopper 2, abrasive feeder vessel 3, pressure equilibration conduit 4, abrasive feeder 5, abrasive funnel 6, abrasive actuated valve 7, abrasive conduit 8, high-pressure-water actuated valve 9, entrainment-style abrasive cutting head 10, and focusing tube 11.

### DETAILED DESCRIPTION OF EMBODIMENTS OF THE INVENTION

The methods and systems (equivalently, apparatus) of the present invention will be described in detail by reference to various non-limiting embodiments.

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with the accompanying drawings.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms, except when used in Markush groups. Thus in some embodiments not otherwise explicitly recited, any instance of “comprising” may be replaced by “consisting of” or, alternatively, by “consisting essentially of.”

The present invention provides improved methods and systems to convey an abrasive in order to cut an underwater object. The object to be cut is submerged within a body of water, which is typically a sea or ocean, but can also be a lake, a reservoir, a river, a pond, or a wetland, for example. In this specification, the term “subsea” may be used, with the understanding that the body of water is not necessarily a sea. By “underwater” it is meant that the object to be cut is resting at the bottom of a body of water, although in principle some movement of the object may take place naturally (e.g., due to pressure or thermal gradients) or may take place while the object is being cut.

Some variations of the invention are premised on the avoidance of premixing the water and the abrasive being used in cutting. Instead, the abrasive and high-pressure water are not mixed until they both reach the cutting head. The abrasive/water mixture passes through a focusing tube and is directed to an underwater object to be cut. This configuration overcomes several problems, including severe abrasive-induced erosion, as well as abrasive plugging.

The design disclosed herein provides dry abrasive to an entrainment-style abrasive cutting nozzle. As high-pressure fluid such as water flows through an orifice, a high-velocity jet is formed. An entrainment-style cutting head contains an open region around the high-velocity jet that is connected to the exterior of the cutting head where a tube is connected. When a high-velocity jet is flowing, it entrains gas from the surroundings into the tube and out of the cutting-head focusing tube. This entrainment of gas (e.g., air) is used to convey abrasive from an abrasive source into the cutting head where the abrasive mixes with the high-velocity fluid jet. The combined gas/abrasive/high-velocity fluid jet lastly issues from the focusing tube where it is directed at the surface to be cut. The abrasive may be metered into the tube (abrasive line) at the desired flow rate. The abrasive feeder is commonly located in an open-air environment and thus the entrained air originates from the surroundings, typically at 1 atm pressure.

Some variations of the invention provide a method of conveying an abrasive to cut an underwater object, the method comprising:
(a) providing a cutting head comprising a high-pressure-water inlet, an abrasive inlet, a mixing chamber, and a focusing tube that forms an outlet from the mixing chamber;
(b) providing a high-pressure water line that is configured to flow high-pressure water into the mixing chamber via the high-pressure-water inlet;
(c) providing an abrasive line that is configured to flow an abrasive, from an abrasive feeder vessel and through an abrasive valve, into the mixing chamber via the abrasive inlet;
(d) providing a pressurized gas vessel containing a gas at a source pressure, wherein the pressurized gas vessel is connected to a sealed gas-valve chamber that is configured to reduce gas pressure from the source pressure to a conveyance pressure greater than atmospheric pressure, and wherein the sealed gas-valve chamber is directly or indirectly connected to the abrasive feeder vessel;
(e) opening a valve upstream of the cutting head to form a high-velocity waterjet through the focusing tube that receives the high-pressure water from the mixing chamber;
(f) evacuating the abrasive line of residual water;
(g) after step (f), opening the abrasive valve to receive the abrasive from the abrasive feeder vessel into the mixing chamber, and to receive the gas from the abrasive feeder vessel into the mixing chamber, wherein the gas at the conveyance pressure pneumatically conveys the abrasive from the abrasive feeder vessel to the mixing chamber; and
(h) cutting the underwater object using the high-velocity waterjet and the abrasive.

In preferred embodiments, the cutting head is an entrainment-style waterjet cutting head.

The high-pressure water may be at a pressure selected from about 1000 atm to about 10000 atm. In various embodiments, the high-pressure water is at a pressure of about 1000, 1500, 2000, 2500, 3000, 3500, 3750, 4000, 4500, 5000, 6000, 7000, 8000, 9000, or 10000 atm, including any intervening range.

The high-pressure water may be provided from a water reservoir that may be underwater or above the surface. The water reservoir (e.g., tank) contains water that may be filtered water (e.g., using activated carbon and/or softener resin), reverse-osmosis water, distilled water, deionized water, spring water, or a combination thereof, for example. The water preferably has low hardness, such as low concentrations of salts of calcium, iron, and magnesium. The water preferably has a low concentration of total dissolved solids, such as about 500 parts per million (ppm) total dissolved solids or less, preferably about 350 ppm or less. The water preferably has a pH from about 6.5 to about 8.5, such as about 7.0 to about 8.0.

In principle, the high-pressure water can be replaced with another high-pressure liquid. The high-pressure liquid should not be toxic to the marine environment. Examples include, but are not limited to, ethanol, glycerol, and polyvinyl alcohol.

The abrasive may be a ceramic material. The abrasive may be selected from the group consisting of garnet, diamond, silicon carbide, silica, alumina, titanium dioxide, and combinations thereof.

In preferred embodiments, the abrasive is a garnet. A garnet abrasive is an abrasive blasting material consisting of minerals from the garnet family, which includes almandite, andradite, grossularite, pyrope, and spessartite. Garnets have the general chemical formula A₃B₂Si₃O₁₂, where A is a divalent cation (Fe²⁺, Ca²⁺, Mg²⁺, or Mn²⁺) and B is a trivalent cation (Fe³⁺, Al³⁺, or Cr³⁺).

In various embodiments, the abrasive is selected from the group consisting of garnet, diamond, silicon carbide, silica, alumina, aluminosilicate zeolites, zirconium silicate, titanium dioxide, feldspar, apatite, augite, corundum, hornblende, ilmenite, magnetite, olivine, orthoclase, plagioclase, pyrite, quartz, topaz, and combinations thereof.

The abrasive may be characterized by a Mohs hardness, which has a scale of 1 to 10, with 10 being the hardest. Diamond has a Mohs hardness of 10. Garnet typically has a Mohs hardness of about 7 to 8. In some embodiments, the abrasive is selected such that it has a Mohs hardness of about, or at least about, 5, 6, 7, 8, or 9.

The average particle size of the abrasive may be from about 50 microns to about 500 microns, for example. In various embodiments, the average particle size of the abrasive is about, at least about, or at most about 50, 60, 70, 80, 90, 100, 110, 120, 130, 140, 150, 200, 250, 300, 350, 400, 450, or 500 microns, including any intervening range. The particle-size distribution of the abrasive may be unimodal or polymodal.

Particles sizes may be measured by a variety of techniques, including dynamic light scattering, laser diffraction, image analysis, or sieve separation, for example. Dynamic light scattering is a non-invasive, well-established technique for measuring the size and size distribution of particles typically in the submicron region, and with the latest technology down to 1 nanometer. Laser diffraction is a widely used particle-sizing technique for materials ranging from hundreds of nanometers up to several millimeters in size. Exemplary dynamic light scattering instruments and laser diffraction instruments for measuring particle sizes are available from Malvern Instruments Ltd., Worcestershire, UK. Image analysis to estimate particle sizes and distributions can be done directly on photomicrographs, scanning electron micrographs, or other images. Finally, sieving is a conventional technique of separating particles by size.

In some embodiments, the abrasive particles are spherical or approximately spherical particles. In other embodiments, the abrasive particles are non-spherical, such as cubic, pyramidal, rectangular prismatic, polyhedron, rod-shaped, disk-shaped, randomly shaped, or a combination thereof. The abrasive particles may have sharp cutting edges or may be capable of fracturing into pieces having sharp cutting edges.

In some embodiments, the abrasive feeder vessel is connected at an abrasive-feeder inlet to an abrasive hopper that stores the abrasive. In some embodiments, the abrasive feeder vessel is internally configured with an abrasive feeder. In particular, within the abrasive feeder vessel, there is an integrated abrasive feeder. The abrasive feeder may be a KMT IV Feedline abrasive feeder (KMT Waterjet Systems, Baxter Springs, Kansas, USA). Preferably, the abrasive feeder is an electronically controlled feeder with variable speed control. The abrasive feed control may be performed on a computer in electrical communication with the abrasive feeder. The computer may store tables or algorithms for determining the flow rate of abrasive for a given target object or desired cut time, for example, and these parameters may be automatically transferred to an electronic control card in the abrasive feeder IV. Nominal flow rates may also be set on a potentiometer, for example.

An abrasive funnel may be disposed at an outlet of the abrasive feeder, at a distal end relative to the abrasive-feeder inlet. The abrasive funnel receives the controlled quantity (rate) of abrasive, set by the electronically controlled abrasive feeder. The abrasive funnel directs the flowing abrasive to the abrasive actuated valve.

In some embodiments, the gas-valve chamber is directly connected to the abrasive feeder vessel. In some embodiments, the gas-valve chamber is connected to an abrasive hopper. In certain embodiments, the gas-valve chamber is connected to both the abrasive feeder vessel and the abrasive hopper.

The gas may be selected from the group consisting of air, nitrogen, argon, carbon dioxide, and combinations thereof. Preferably, the gas is a dry gas, such as dry air. In this specification, a “dry gas” means that the gas has a dew point less than the operating temperature, avoiding water condensation. The dew point is a function of the gas temperature and the relative humidity of the gas.

In step (d), there is at least one pressurized gas vessel. Multiple pressurized gas vessels may be utilized, potentially with different volumes or pressures. In certain embodiments, standard scuba air jugs are utilized.

The source pressure for the gas may be selected from about 10 atm to about 250 atm. In various embodiments, the source pressure for the gas is selected from about 10, 20, 30, 40, 50, 60, 70, 80, 90, 100, 110, 120, 130, 140, 150, 160, 170, 180, 190, 200, 210, 220, 230, 240, or 250 atm, including any intervening range.

The conveyance pressure for the gas may be selected from about 1.1 atm to about 2 atm, for example. Higher conveyance pressures may be used, such as 5 atm. In various embodiments, the conveyance pressure is about 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.5, 4.0, 4.5, or 5.0 atm, including any intervening range (for example, the conveyance pressure may be selected from 1.2-2.5 atm).

In some embodiments, the sealed gas-valve chamber contains a blanketing regulator valve that maintains the conveyance pressure of the gas feeding into the abrasive feeder vessel.

The sealed gas-valve chamber is at a reference pressure, which is typically 1 atm. The reference pressure is less than the source pressure. In preferred embodiments, the reference pressure is less than the conveyance pressure. In various embodiments, the reference pressure is about 0.8, 0.9, 1.0, 1.1, 1.2, 1.3, 1.4, 1.5, 1.6, 1.7, 1.8, 1.9, or 2.0 atm, including any intervening range.

In some embodiments, step (f) evacuates the abrasive line of residual water using the Venturi effect by flowing high-pressure water past the abrasive inlet for at least 10 seconds. In some embodiments, step (f) evacuates the abrasive line of residual water using flow of gas through the abrasive line. In certain embodiments, step (f) evacuates the abrasive line of residual water using both (i) the Venturi effect by flowing high-pressure water past the abrasive inlet for at least 10 seconds and (ii) flow of gas through the abrasive line, either simultaneously or at different times. In various embodiments, high-pressure water flows past the abrasive inlet for at least 10 seconds, 20 seconds, 30 seconds, 1 minute, 2 minutes, 5 minutes, or longer.

Step (f) may employ an abrasive flow rate from about 0.1 pounds per minute to about 2 pounds per minute, for example. In various embodiments, step (f) employs an abrasive flow rate of about, at least about, or at most about 0.01, 0.05, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.5, 3, 3.5, 4, 4.5, 5, 6, 7, 8, 9, or 10 pounds per minute, including any intervening range.

Step (g) may employ a gas flow rate from about 1 standard cubic feet per minute to about 5 standard cubic feet per minute, for example. In various embodiments, step (g) employs a gas flow rate of about, at least about, or at most about 0.1, 0.5, 1, 2, 3, 4, 5, 6, 7, 8, 9, or 10 standard cubic feet per minute.

In step (h), the underwater object being cut may be a discarded military munition or an unexploded ordnance, for example. The discarded military munition may have been recently discarded, such as within the previous 12 months, or discarded many years or decades previously, such as during or shortly after World War II. Ocean disposal of munitions was an accepted international practice until 1970, when it was prohibited by the U.S. Department of Defense. Unexploded ordnances are explosive weapons, such as bombs, bullets, shells, projectiles, grenades, or mines that did not explode when they were employed and still pose a risk of detonation. The unexploded ordnance may have been recently employed (but unexploded), such as within the previous 12 months, or employed (but unexploded) many years or decades previously. For both discarded military munitions and unexploded ordnances, the primary goal of cutting is to render safe the underwater object. Optionally, the chemical contents (e.g., trinitrotoluene, ammonium picrate, etc.) of the discarded military munition or unexploded ordnance may be captured in some fashion, rather than allowing the contents to disperse into the body of water, which is typically a sea or ocean.

Other types of underwater objects may be cut, such as marine vessels or rock formations, for example. There is a demand for underwater cutting of metals or stone, for activities such as mining, salvage (e.g., shipwrecks), rescue work, infrastructure development (e.g., pipelines), petroleum exploration, and environmental remediation. An example of underwater cutting of rocks is the clearing of passageways for underwater communications and electrical power infrastructure.

Some variations of the invention provide a system for conveying an abrasive intended to cut an underwater object, the system comprising:
(a) a cutting head comprising a high-pressure-water inlet, an abrasive inlet, a mixing chamber, and a focusing tube that forms an outlet from the mixing chamber;
(b) a high-pressure water line that is configured to flow high-pressure water into the mixing chamber via the high-pressure-water inlet, wherein the focusing tube is configured to receive the high-pressure water from the mixing chamber;
(c) an abrasive line that is configured to flow an abrasive, from an abrasive feeder vessel and through an abrasive valve, into the mixing chamber via the abrasive inlet; and
(d) a pressurized gas vessel containing a gas at a source pressure, wherein the pressurized gas vessel is connected to a sealed gas-valve chamber that is directly or indirectly connected to the abrasive feeder vessel, wherein the sealed gas-valve chamber is configured to reduce gas pressure from the source pressure to a conveyance pressure greater than atmospheric pressure,
wherein, when the abrasive valve is open, (i) the abrasive is conveyed from the abrasive feeder vessel into the mixing chamber and (ii) the gas at the conveyance pressure pneumatically conveys the abrasive from the abrasive feeder vessel to the mixing chamber, and wherein the focusing tube is configured to direct the high-velocity waterjet and the abrasive onto the underwater object.

In preferred systems, the cutting head is an entrainment-style waterjet cutting head.

In some systems, the abrasive feeder vessel is connected at an abrasive-feeder inlet to an abrasive hopper that stores the abrasive. The abrasive feeder vessel may be internally configured with an abrasive feeder, and a funnel may be disposed at an outlet of the abrasive feeder, at a distal end relative to the abrasive-feeder inlet.

In some systems, the gas-valve chamber is directly connected to the abrasive feeder vessel. In some systems, the gas-valve chamber is connected to the abrasive hopper. In certain systems, the gas-valve chamber is connected to both the abrasive feeder vessel and the abrasive hopper.

In some systems, the sealed gas-valve chamber contains a blanketing regulator valve that is configured to maintain the conveyance pressure of the gas feeding into the abrasive feeder vessel.

The underwater object to be cut may be a discarded military munition or an unexploded ordnance, for example. Note that the actual underwater object may not (yet) be present, such as at the time the system is built, while the system is being shipped, while the system is being stored (e.g., above water on a ship), or while the system is underwater roaming to find an object to cut.

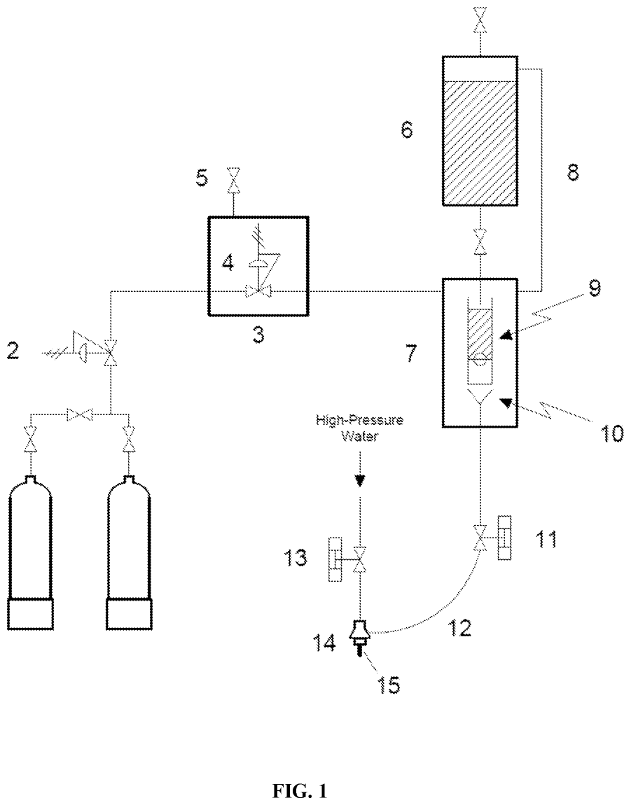

FIG. 1 is an exemplary system for conveying an abrasive intended to cut an underwater object, in some variations. FIG. 1 include gas storage 1, forward pressure regulator 2, blanketing regulator valve chamber 3, blanketing regulator valve 4, chamber reference pressure valve 5, abrasive hopper 6, abrasive feeder vessel 7, pressure equilibration conduit 8, abrasive feeder 9, abrasive funnel 10, abrasive actuated valve 11, abrasive conduit 12, high-pressure-water actuated valve 13, entrainment-style abrasive cutting head 14, and focusing tube 15.

In FIG. 1, gas storage 1 is depicted as two gas cylinders or jugs (e.g., standard scuba air jugs). Gas storage 1 is connected to the forward pressure regulator 2, which is connected to blanketing regulator valve chamber 3. The blanketing regulator valve chamber 3 houses the blanketing regulator valve 4. The chamber reference pressure valve 5 is connected to the blanketing regulator valve chamber 3. The blanketing regulator valve chamber 3 is sealed from the environment. The blanketing regulator valve chamber 3 reduces gas pressure from the source pressure (at gas storage 1) to a conveyance pressure greater than atmospheric pressure. The output of the blanketing regulator valve 4 is connected to the abrasive feeder vessel 7. Within the abrasive feeder vessel 7, the abrasive feeder 9 receives abrasive from the abrasive hopper 6. The abrasive hopper 6 and the abrasive feeder vessel 7 are pressure-equilibrated via the pressure equilibration conduit 8. An abrasive funnel 10 is disposed at the distal end of the abrasive feeder 9, relative to the inlet (hopper side) of the abrasive feeder 9. The abrasive actuated valve 11 is connected to the abrasive funnel 10. When the abrasive actuated valve 11 is open, that valve allows flow of abrasive or gas (e.g., air) via the abrasive conduit 12 to the abrasive cutting head 14. Additionally, when the abrasive actuated valve 11 is open, the gas at the conveyance pressure pneumatically conveys the abrasive from the abrasive feeder vessel 7 to the abrasive cutting head 14. High-pressure water enters into the abrasive cutting head 14 via the high-pressure-water actuated valve 13. The abrasive cutting head 14 has a mixing chamber where high-pressure water and abrasive mix together. The abrasive cutting head 14 is configured with a focusing tube 15 that forms an outlet of the mixture of high-pressure water and abrasive from the mixing chamber of the abrasive cutting head 14. The focusing tube 15 directs the high-velocity waterjet and the abrasive onto the underwater object to be cut.

Many of the principles of the invention may be applied to shallow water. In this specification, “shallow” means 500 feet depth or less.

Some variations of the invention provide a method of conveying an abrasive to cut an object submerged in shallow water, the method comprising:
(a) providing a cutting head comprising a high-pressure-water inlet, an abrasive inlet, a mixing chamber, and a focusing tube that forms an outlet from the mixing chamber;
(b) providing a high-pressure water line that is configured to flow high-pressure water into the mixing chamber via the high-pressure-water inlet;
(c) providing an abrasive line that is configured to flow an abrasive, from an abrasive feeder vessel and through an abrasive valve, into the mixing chamber via the abrasive inlet;
(d) providing an air conduit configured to supply ambient air directly or indirectly to the abrasive feeder vessel;
(e) opening a valve upstream of the cutting head to form a high-velocity waterjet through the focusing tube that is configured to receive the high-pressure water from the mixing chamber;
(f) evacuating the abrasive line of residual water;
(g) after step (f), opening the abrasive valve to receive the abrasive from the abrasive feeder vessel into the mixing chamber, and to receive the ambient air from the abrasive feeder vessel into the mixing chamber, wherein the ambient air pneumatically conveys the abrasive from the abrasive feeder vessel to the focusing tube; and
(h) cutting the underwater object using the high-velocity waterjet and the abrasive.

Other variations of the invention provide a system for conveying an abrasive intended to cut an underwater object submerged in shallow water, the system comprising:
a cutting head comprising a high-pressure-water inlet, an abrasive inlet, a mixing chamber, and a focusing tube that forms an outlet from the mixing chamber;
a high-pressure water line that is configured to flow high-pressure water into the mixing chamber via the high-pressure-water inlet, wherein the focusing tube is configured to receive the high-pressure water from the mixing chamber;
an abrasive line that is configured to flow an abrasive, from an abrasive feeder vessel and through an abrasive valve, into the mixing chamber via the abrasive inlet; and
an air conduit configured to supply ambient air directly or indirectly to the abrasive feeder vessel,
wherein, when the abrasive valve is open, (i) the abrasive is conveyed from the abrasive feeder vessel into the mixing chamber and (ii) the gas pneumatically conveys the abrasive from the abrasive feeder vessel to the focusing tube, and wherein the focusing tube is configured to direct the high-velocity waterjet and the abrasive onto the underwater object.

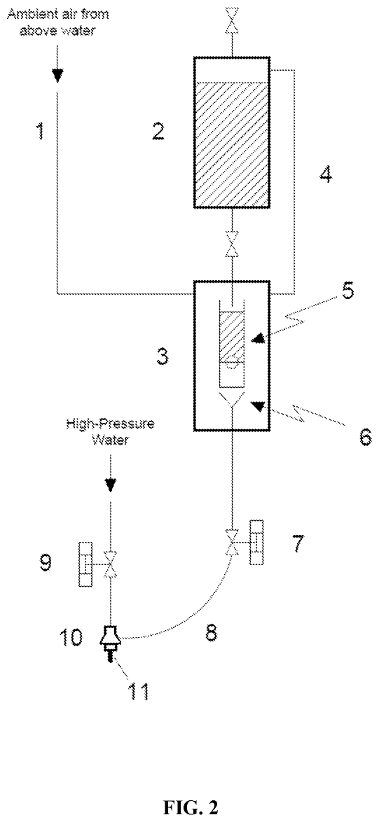

FIG. 2 is an exemplary system for conveying an abrasive intended to cut an underwater object submerged in shallow water, in some variations. FIG. 2 includes vent line 1 (to surface above water), abrasive hopper 2, abrasive feeder vessel 3, pressure equilibration conduit 4, abrasive feeder 5, abrasive funnel 6, abrasive actuated valve 7, abrasive conduit 8, high-pressure-water actuated valve 9, entrainment-style abrasive cutting head 10, and focusing tube 11.

In FIG. 2, vent line 1 pulls in ambient air from above the surface of the body of water. The vent line 1 is connected to the abrasive feeder vessel 3. Within the abrasive feeder vessel 3, the abrasive feeder 5 receives abrasive from the abrasive hopper 2. The abrasive hopper 2 and the abrasive feeder vessel 3 are pressure-equilibrated via the pressure equilibration conduit 4. An abrasive funnel 6 is disposed at the distal end of the abrasive feeder 5, relative to the inlet (hopper side) of the abrasive feeder 5. The abrasive actuated valve 7 is connected to the abrasive funnel 6. When the abrasive actuated valve 7 is open, that valve allows flow of abrasive or air via the abrasive conduit 8 to the abrasive cutting head 10. Additionally, when the abrasive actuated valve 8 is open, the air pneumatically conveys the abrasive from the abrasive feeder vessel 3 to the abrasive cutting head 10. High-pressure water enters into the abrasive cutting head 10 via the high-pressure-water actuated valve 9. The abrasive cutting head 10 has a mixing chamber where high-pressure water and abrasive mix together. The abrasive cutting head 10 is configured with a focusing tube 11 that forms an outlet of the mixture of high-pressure water and abrasive from the mixing chamber of the abrasive cutting head 10. The focusing tube 11 directs the high-velocity waterjet and the abrasive onto the underwater object to be cut.

Various embodiments of the invention, and the principles employed, will now be described in even more detail—without intending to limit the scope of the invention as defined by the claims.

To pneumatically convey abrasive subsea in a closed system, a gas supply is required. Common suitable gases include dry air and nitrogen although any gas, provided it is compatible with the system and cannot condense at the operating pressure and temperature, can be used. Moisture can lead to agglomeration of the abrasive and subsequently lead to plugging. Therefore, dry gas is preferred and should have a dew point below the operating temperature.

In normal (not shallow) operation, the gas is contained in one or more suitable vessels. Since a finite amount of gas can be carried subsea, vessels containing pressurized gas are preferred. For air, standard scuba jugs can be used. Multiple scuba jugs can be used simultaneously if manifolded to a common outlet. Following the manifold is a forward pressure regulator to drop the gas pressure from storage vessel pressure to a lower pressure. Common scuba jug pressure regulators drop the air pressure from an initial jug pressure of 3,000 psig (204 atm) to 100-150 psig (about 7-10 atm) after the regulator.

The gas leaving the forward pressure regulator is plumbed into another forward pressure regulator that further reduces the pressure. This forward pressure regulator is used to maintain a downstream pressure slightly above 1 atm (absolute). A common blanketing regulating valve can be used; these valves have a spring and diaphragm construction. As one suitable example, refer to Technical Bulletin 1088-TB for the Model 1088 Vacu-Gard Tank Blanketing Valve, which is hereby incorporated by reference. The pressure difference observed from one side of the diaphragm (reference side) to the other (sensing side) allows for the spring to move the valve spindle. The spring is preloaded to achieve the desired gas outlet pressure above the reference-side ambient pressure. In order to use this regulating valve subsea, the reference side of the diaphragm needs to be maintained at a constant reference pressure regardless of depth subsea. This constraint is accomplished by housing the valve inside a sealed vessel (chamber) that is at 1 atm (absolute). The gas inlet to the valve and the gas outlet of the valve are plumbed through the wall of the vessel. This arrangement keeps the exterior of the regulating valve and hence the reference side of the diaphragm at the pressure (1 atm absolute) inside the chamber. Prior to deployment of the system subsea, the regulating valve chamber is opened to local ambient pressure and then sealed closed with a manual valve to ensure the chamber is tightly sealed at local ambient pressure (1 atm absolute). As a result, the reference side of the diaphragm is maintained at a constant pressure regardless of depth subsea.

The gas outlet line from the regulating valve passes through the chamber wall and is plumbed to the abrasive feeder vessel and/or the abrasive hopper. It is desired to keep both vessels at the same pressure as the pressure setpoint of the regulating valve. The gas outlet line may be plumbed to one of the two vessels and then the two vessels may be joined with another conduit such that they are both maintained at the same pressure (a pressure equilibration conduit is used in both FIGS. 1 and 2). In some embodiments, a single vessel is used with internal geometry and configuration such that abrasive is held at the top and the abrasive feeder is below the top region. A two-vessel arrangement is described next, and is the configuration shown in FIGS. 1 and 2.

The abrasive hopper is a vessel that holds a finite amount of abrasive that is used by the cutting head. The size of the abrasive hopper is dictated by the quantity of abrasive to be deployed subsea. This hopper is mounted above the abrasive feeder vessel so that gravity can be used to keep the feeder full of abrasive. A valve can be used in between the abrasive hopper vessel and the abrasive feeder vessel, if desired, to allow for isolation if the vessels need to be separated for maintenance. The headspace above the abrasive in the hopper is maintained at the pressure of the blanketing regulator valve setpoint, which is set by the spring. Typically, this pressure is around 1 psig greater than the reference pressure in the regulating valve chamber. The regulated gas outlet pressure only needs to be slightly greater than the reference pressure. The valve must be sized to deliver the required flow rate of gas.

The abrasive feeder is located in the abrasive feeder vessel which itself is located below the abrasive hopper. Typical abrasive feeders are electromechanical devices that dispense abrasive at a desired flow rate. The feeder is electrically powered and can be controlled via electrical signals to vary the abrasive delivery rate. The abrasive feeder is mounted inside the feeder vessel and the abrasive held in the abrasive hopper is plumbed internally into the top of the abrasive feeder. The abrasive dispensed from the feeder is dropped into a funnel whose outlet is plumbed out of the abrasive feeder vessel and into an actuated valve located external to the abrasive feeder vessel. The actuated valve is used to prevent the backflow of water into the abrasive feeder vessel. Lastly, the outlet of the actuated valve is plumbed to the cutting head with an abrasive feed line.

In some variations of the invention, the normal order of operations for cutting subsea with an abrasive entrainment-style waterjet cutting head is as follows:
First, the high-pressure waterjet cutting head is turned on by opening a high-pressure water valve upstream of the cutting head. This action allows for the formation of a high-velocity waterjet that exits the focusing tube. Inherently, via the Venturi effect, the mixing chamber and abrasive line up to the actuated valve are evacuated. A deep vacuum, limited by the vapor pressure of water at the operational temperature, is generated and pulls any water in the abrasive line out and through the cutting head. This action also begins to dry the abrasive line. A wet abrasive line will rapidly plug with abrasive. Therefore, the high-pressure-water flow needs to be performed for enough time to evacuate the abrasive line of wet abrasive. Typically a minimum of 10 seconds of high-pressure-water flow is required to evacuate the abrasive line. There is no problem using a longer time of high-pressure-water flow. After the wait time, the actuated valve at the outlet of the abrasive feeder vessel is opened. When this happens, gas is immediately drawn from the abrasive feeder vessel (which is connected to the abrasive hopper) and flows to the cutting head. Both air and water now issue from the focusing tube.

Note that when the cutting head is not used, surrounding seawater will backflow into the abrasive line up to the closed actuated valve. The actuated valve must be closed when the cutting head is not used to prevent water from backflowing into the abrasive feeder vessel. Water backflow into the abrasive feeder vessel can cause problems with the electrical components of the abrasive feeder, especially due to the cold temperature of seawater at significant depths.

For convenience, the term “air” will now be used instead of “gas” since dry air is the most common gas for pneumatically conveying abrasive to the cutting head. It will be understood that the air may be replaced with nitrogen or CO₂, for example.

When the pressure in abrasive feeder vessel and abrasive hopper drop below the reference pressure, the blanketing regulator valve automatically opens to deliver air to the abrasive feeder vessel and to the abrasive hopper. It is this air that pneumatically conveys the abrasive to the cutting head when it enters the funnel from the feeder. At this point, the abrasive feeder is not on yet and only air is flowing through the abrasive line to the cutting head. This air flow further dries the abrasive line. Typically, another 10 seconds are allowed to elapse to ensure the abrasive line is completely dry. Again, longer dry times may be used.

The air originates from a storage vessel at high pressure, such as a plurality of scuba jugs on a common manifold. This air flows through the first forward pressure regulator and into the blanketing regulator valve held in its chamber at the reference pressure. The air then flows out of the regulator valve and into the abrasive feeder vessel and abrasive hopper, and then exits the bottom of the abrasive feeder vessel through the abrasive line, through the actuated valve, and into the cutting head. If the actuated valve is now closed, the abrasive line after the actuated valve again evacuates and air flow stops. Upstream of the actuated valve, the blanketing regulator valve allows air to flow into the abrasive feeder vessel and abrasive hopper until their pressure reaches the blanketing regulator valve setpoint; when this point is reached, the blanketing regulator valve automatically closes and air flow stops. Therefore, the only time air is consumed in this system is when the cutting head is flowing high-pressure water and the actuated valve is open.

Next, the abrasive feeder is turned on at the desired abrasive flow rate. The abrasive feeder dispenses abrasive into the funnel that is attached to the abrasive line/actuated valve. Air is already flowing through this line and pneumatically conveys the abrasive to the cutting head. The cutting head proceeds to cut the target surface for an effective amount of time to partially or fully cut the underwater object.

After cutting of the underwater object is complete—or the cutting will be stopped for a period of time, to be resumed at a later time—the following operations may be used to shut down the underwater abrasive feed system.

First, the abrasive feed is stopped. Thus, no abrasive is dispensed into the funnel/abrasive line. The abrasive feed is typically stopped by closing the valve between the abrasive hopper and the abrasive feeder vessel.

After a short period of time, on the order of seconds, the abrasive actuated valve is closed. This delay in closing the abrasive actuated valve ensures that the abrasive line is cleared of abrasive. After the abrasive actuated valve is closed, the abrasive conduit after the valve becomes evacuated of air. The air flow into the abrasive feeder vessel and abrasive hopper stops as soon as the pressure in those vessels reaches the setpoint prescribed by the blanketing regulator valve.

Next, the high-pressure-water flow to the abrasive cutting head is stopped by closing the high-pressure-water actuated valve. At this point, surrounding seawater will flow backwards through the cutting head and into the abrasive conduit, up to the abrasive actuated valve, since this line was previously under vacuum.

Typical abrasive flow rates are from 0.1 to 2 pounds per minute. Typical abrasive conduit size is ⅜″ OD by 9/32″ ID. Typical abrasive conduit material is Nylon (polyamide) tubing. Other polymers may be used for the abrasive conduit material, such as (but not limited to) polyethylene, polypropylene, polyurethane, or polyvinyl chloride. The abrasive conduit material may also be a metal, such as stainless steel (e.g., flexible 316 stainless steel tubing). The abrasive conduit material must be fabricated from a material such that the line does not collapse at depth due to external pressure.

The air flow induced in the abrasive conduit by the Venturi effect in the cutting head is proportional to the orifice diameter in the cutting head and the square root of the pressure of the high-pressure water upstream of the orifice. For common cutting head configurations, the air flow rate typically ranges from 1 to 5 standard cubic feet per minute (SCFM).

All vessels and other equipment must be designed to withstand the external pressure experienced at the water depth of operation. Thus, the operational limit of a given system design is primarily dictated by its design to withstand the external pressure at its operational depth.

The internal pressure maintained downstream of the blanketing regulator valve only has to be large enough to achieve the required air flow rate for pneumatically conveying the abrasive. This equipment can be maintained at larger pressures, if desired, provided the vessels can support it. In some embodiments, electronic components used within the abrasive feeder vessel can collapse if they experience large external pressures, which places a limit on the internal pressure maintained downstream of the blanketing regulator valve.

If operating in shallow water, one can eliminate both carrying air subsea and using the blanketing regulator valve and its chamber. Instead, the abrasive feeder vessel and abrasive hopper can be simply vented via an open conduit (tube) from the above surface to the vessel and hopper. This line can be used to supply ambient air to the system. The present inventor has recognized that when abrasive feeders are used above water, the ambient air is simply drawn into the abrasive line. Thus, the use of a vent line allows shallow-water operation that is, in some respects, the same as above-water abrasive feeder operation. Note that even in shallow water, the entire system as disclosed in FIG. 1 may still be used, including the gas source, the blanketing regulator valve, and the blanketing regulator valve chamber.

In normal (deep water) operation, the only two factors that limit the length of time the system can operate subsea are the quantity of gas (e.g., air) and quantity of abrasive taken subsea. When either the gas or the abrasive is exhausted, the system can be returned to the surface to be recharged. Fortunately, abrasive is very dense and a lot of material can be taken subsea at one time. In some embodiments, an empty gas cylinder can be swapped out with a full gas cylinder, underwater using stab connectors so that the system need not be returned to the surface.

There is only one cable that must be attached from the abrasive feeder vessel to the control system. This cable supplies power to the feeder and its control signals to vary the abrasive feed rate. Subsea cabling and connectors may be used to accomplish this configuration.

In this detailed description, reference has been made to multiple embodiments and to the accompanying drawings in which are shown by way of illustration specific exemplary embodiments of the invention. These embodiments are described in sufficient detail to enable those skilled in the art to practice the invention, and it is to be understood that modifications to the various disclosed embodiments may be made by a skilled artisan.

Where methods and steps described above indicate certain events occurring in certain order, those of ordinary skill in the art will recognize that the ordering of certain steps may be modified and that such modifications are in accordance with the variations of the invention. Additionally, certain steps may be performed concurrently in a parallel process when possible, as well as performed sequentially.

All publications, patents, and patent applications cited in this specification are herein incorporated by reference in their entirety as if each publication, patent, or patent application were specifically and individually put forth herein.

The embodiments, variations, and figures described above should provide an indication of the utility and versatility of the present invention. Other embodiments that do not provide all of the features and advantages set forth herein may also be utilized, without departing from the spirit and scope of the present invention. Such modifications and variations are considered to be within the scope of the invention defined by the claims.

What is claimed is:

1. A method of conveying an abrasive to cut an underwater object, said method comprising:
(a) providing a cutting head comprising a high-pressure-water inlet, an abrasive inlet, a mixing chamber, and a focusing tube that forms an outlet from said mixing chamber;
(b) providing a high-pressure water line that is configured to flow high-pressure water into said mixing chamber via said high-pressure-water inlet;
(c) providing an abrasive line that is configured to flow an abrasive, from an abrasive feeder vessel and through an abrasive valve, into said mixing chamber via said abrasive inlet;
(d) providing a pressurized gas vessel containing a gas at a source pressure, wherein said pressurized gas vessel is connected to a sealed gas-valve chamber that is configured to reduce gas pressure from said source pressure to a conveyance pressure greater than atmospheric pressure, and wherein said sealed gas-valve chamber is directly or indirectly connected to said abrasive feeder vessel;
(e) opening a valve upstream of said cutting head to form a high-velocity waterjet through said focusing tube that receives said high-pressure water from said mixing chamber;
(f) evacuating said abrasive line of residual water;
(g) after step (f), opening said abrasive valve to receive said abrasive from said abrasive feeder vessel into said mixing chamber, and to receive said gas from said abrasive feeder vessel into said mixing chamber, wherein said gas at said conveyance pressure pneumatically conveys said abrasive from said abrasive feeder vessel to said mixing chamber; and
(h) cutting said underwater object using said high-velocity waterjet and said abrasive.

2. The method of claim 1, wherein said cutting head is an entrainment-style waterjet cutting head.

3. The method of claim 1, wherein said high-pressure water is at a pressure selected from about 1000 atm to about 10000 atm.

4. The method of claim 1, wherein said abrasive is selected from the group consisting of garnet, diamond, silicon carbide, silica, alumina, titanium dioxide, and combinations thereof.

5. The method of claim 1, wherein said abrasive feeder vessel is connected at an abrasive-feeder inlet to an abrasive hopper that stores said abrasive.

6. The method of claim 1, wherein said abrasive feeder vessel is internally configured with an abrasive feeder, and wherein a funnel is disposed at an outlet of said abrasive feeder, at a distal end relative to said abrasive-feeder inlet.

7. The method of claim 1, wherein said gas-valve chamber is directly connected to said abrasive feeder vessel.

8. The method of claim 5, wherein said gas-valve chamber is connected to said abrasive hopper.

9. The method of claim 5, wherein said gas-valve chamber is connected to both said abrasive feeder vessel and said abrasive hopper.

10. The method of claim 1, wherein said gas is selected from the group consisting of air, nitrogen, argon, carbon dioxide, and combinations thereof.

11. The method of claim 1, wherein said gas is dry air.

12. The method of claim 1, wherein said source pressure is selected from about 10 atm to about 250 atm.

13. The method of claim 1, wherein said conveyance pressure is selected from about 1.1 atm to about 2 atm.

14. The method of claim 1, wherein said sealed gas-valve chamber is at a reference pressure that is less than said conveyance pressure.

15. The method of claim 14, wherein said sealed gas-valve chamber contains a blanketing regulator valve that maintains said conveyance pressure of said gas feeding into said abrasive feeder vessel.

16. The method of claim 1, wherein step (f) evacuates said abrasive line of residual water using the Venturi effect by flowing said high-pressure water past said abrasive inlet for at least 10 seconds.

17. The method of claim 1, wherein step (f) evacuates said abrasive line of residual water using flow of said gas through said abrasive line.

18. The method of claim 1, wherein step (i) evacuates said abrasive line of residual water using both (a) the Venturi effect by flowing said high-pressure water past said abrasive inlet for at least 10 seconds and (ii) flow of said gas through said abrasive line.

19. The method of claim 1, wherein step (g) uses an abrasive flow rate from about 0.1 pounds per minute to about 2 pounds per minute.

20. The method of claim 1, wherein step (g) uses a gas flow rate from about 1 standard cubic feet per minute to about 5 standard cubic feet per minute.

21. A system for conveying an abrasive intended to cut an underwater object, said system comprising:
(a) a cutting head comprising a high-pressure-water inlet, an abrasive inlet, a mixing chamber, and a focusing tube that forms an outlet from said mixing chamber;
(b) a high-pressure water line that is configured to flow high-pressure water into said mixing chamber via said high-pressure-water inlet, wherein said focusing tube is configured to receive said high-pressure water from said mixing chamber;
(c) an abrasive line that is configured to flow an abrasive, from an abrasive feeder vessel and through an abrasive valve, into said mixing chamber via said abrasive inlet; and
(d) a pressurized gas vessel containing a gas at a source pressure, wherein said pressurized gas vessel is connected to a sealed gas-valve chamber that is directly or indirectly connected to said abrasive feeder vessel, wherein said sealed gas-valve chamber is configured to reduce gas pressure from said source pressure to a conveyance pressure greater than atmospheric pressure,
wherein, when said abrasive valve is open, (i) said abrasive is conveyed from said abrasive feeder vessel into said mixing chamber and (ii) said gas at said conveyance pressure pneumatically conveys said abrasive from said abrasive feeder vessel to said mixing chamber, and wherein said focusing tube is configured to direct said high-velocity waterjet and said abrasive onto said underwater object.

22. The system of claim 21, wherein said cutting head is an entrainment-style waterjet cutting head.

23. The system of claim 21, wherein said abrasive feeder vessel is connected at an abrasive-feeder inlet to an abrasive hopper that stores said abrasive.

24. The system of claim 23, wherein said abrasive feeder vessel is internally configured with an abrasive feeder, and wherein a funnel is disposed at an outlet of said abrasive feeder, at a distal end relative to said abrasive-feeder inlet.

25. The system of claim 21, wherein said gas-valve chamber is directly connected to said abrasive feeder vessel.

26. The system of claim 23, wherein said gas-valve chamber is connected to said abrasive hopper.

27. The system of claim 23, wherein said gas-valve chamber is connected to both said abrasive feeder vessel and said abrasive hopper.

28. The system of claim 21, wherein said sealed gas-valve chamber contains a blanketing regulator valve that is configured to maintain said conveyance pressure of said gas feeding into said abrasive feeder vessel.

29. The system of claim 21, wherein said underwater object is a discarded military munition.

30. The system of claim 21, wherein said underwater object is an unexploded ordnance.
